(19) United States
(12) Patent Application Publication
(10) Pub. No.: US 2017/0273329 A1
(43) Pub. Date: Sep. 28, 2017

(54) METHOD FOR PRODUCING UNIFORMLY COLORED TOFU

(71) Applicant: KANEMATSU CHEMICALS CORPORATION, Tokyo (JP)

(72) Inventors: Yasunao MORI, Saitama (JP); Yasushi MIZOGUCHI, Tokyo (JP); Yoshinori TAKADA, Tokyo (JP)

(21) Appl. No.: 15/082,105

(22) Filed: Mar. 28, 2016

(51) Int. Cl. A23C 20/02; A23C 20/00; A23L 19/00; A23L 29/20; A23L 11/00; A23L 27/30

(52) U.S. Cl. CPC A23C 20/025; A23L 11/05; A23L 27/34; A23L 19/01; A23L 29/20; A23C 20/005; A23V 2002/00

(57) ABSTRACT

In accordance with the present invention, there is provided a method for producing colored tofu, the method comprising a step of preparing a liquid dispersion constituted by a colorant and a paste or powder of vegetables or fruit uniformly dispersed in sugar alcohol or a dilute aqueous solution thereof; a step of preparing a liquid soy milk mixture by uniformly mixing the liquid dispersion, soy milk, and a coagulating agent; and a step of coagulating the liquid soy milk mixture to produce tofu.

### FIELD OF THE INVENTION

The present invention relates to a method for producing tofu, and, in particular, to a method for producing colored tofu.

### BACKGROUND OF THE INVENTION

The majority of colored tofu currently sold on the market is constituted by tofu mixed with crushed food ingredients such as herbs, or tofu mixed with synthetic flavorings and colors.

In tofu mixed with crushed food ingredients such as herbs, however, the crushed food ingredients are dispersed in patches throughout the tofu, leading to a problematic lack of uniformity in coloration and flavor. In some cases, moreover, the mixed-in food ingredients may settle to the bottom of the tofu.

Meanwhile, while the color and flavor are uniformly distributed throughout the entirety of the tofu in the case of tofu mixed with synthetic flavorings and colors, it is impossible to add food ingredients, especially natural food ingredients, leading to the problem that it is impossible to impart the flavors of food ingredients themselves.

### SUMMARY OF THE INVENTION

Therefore, an object of the present invention is to provide a method for producing colored tofu, wherein a food ingredient is added thereto, and the tofu has a uniform color distribution.

In order to achieve the object proposed above, the inventors struck upon the idea that first preparing a liquid dispersion constituted by a colorant and a paste or powder of vegetables or fruit uniformly dispersed in sugar alcohol or a dilute aqueous solution thereof, followed by mixing this liquid dispersion with soy milk and a coagulating agent in a subsequent step, might make it possible to achieve a uniform color distribution. As the result of repeated experimentation based upon this concept, the inventors formulated the method for producing colored tofu according to the present invention.

In accordance with a primary aspect of the present invention, there is provided a method for producing colored tofu, the method comprising a step of preparing a liquid dispersion constituted by a colorant and a paste or powder of vegetables or fruit uniformly dispersed in sugar alcohol or a dilute aqueous solution thereof; a step of preparing a liquid soy milk mixture by uniformly mixing the liquid dispersion, soy milk, and a coagulating agent; and a step of coagulating the liquid soy milk mixture to produce tofu.

In accordance with one embodiment of the present invention, the step of preparing the liquid dispersion uses a paste or powder of vegetables or fruit having a particle size of 20 mesh or smaller. In this embodiment, it is more preferable that the paste or powder of vegetables or fruit has a particle size of 30 mesh or smaller.

In accordance with another embodiment of the present invention, the step of preparing the liquid dispersion is a step of further dispersing a thickener within the sugar alcohol or dilute aqueous solution thereof in an amount equivalent to 0.05-1.0% by weight with respect to the total weight of the liquid dispersion. In this embodiment, it is preferable that the thickener be dispersed in the sugar alcohol or dilute aqueous solution thereof in this step in an amount equivalent to 0.1-0.5% by weight with respect to the total weight of the liquid dispersion.

In accordance with the present invention, as discussed above, a liquid dispersion of a uniformly dispersed colorant and food ingredient is first prepared, and the colorant and food ingredient are mixed in the state of this liquid dispersion with soy milk and a coagulating agent, thereby allowing the colorant and food ingredient to be uniformly dispersed throughout the entirety of the tofu, thus making it possible to provide uniformly colored, uniformly flavored tofu. In addition, the present invention allows for the uniform dispersion of a food ingredient within tofu, even if the food ingredient being added is large in particle size or is added to the tofu in a large proportion, by mixing in the food ingredient in the form of a liquid dispersion.

Other characteristics of the present invention apart from those described above are clearly described in the following “DETAILED DESCRIPTION OF THE INVENTION” section and the attached drawing.

### BRIEF DESCRIPTION OF THE DRAWING

FIG. 1 A flow chart depicting a method for producing colored tofu according to an embodiment of the present invention.

### DETAILED DESCRIPTION OF THE INVENTION

An embodiment of the present invention will now be described in detail with reference to the attached drawing.

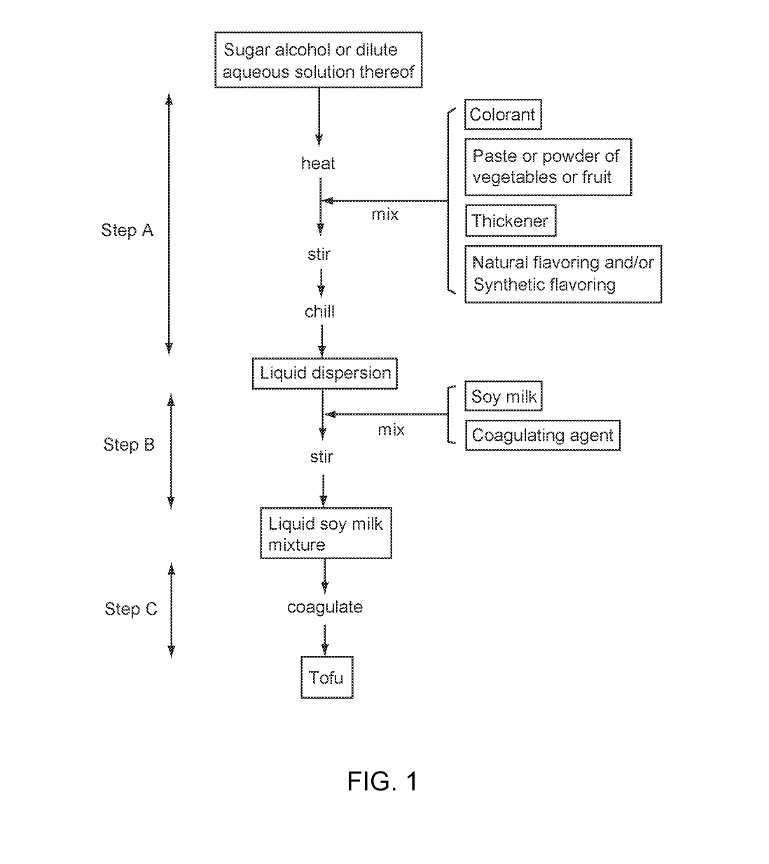

As seen in FIG. 1, a method for producing tofu according to the present embodiment comprises a step A of preparing a liquid dispersion, a step B of preparing a liquid soy milk mixture, and a step C of producing tofu.

In the step A of preparing a liquid dispersion, sugar alcohol or a dilute aqueous solution thereof is first heated to about 70° C. Next, a colorant, a paste or powder of vegetables or fruit, and a thickener are added to the heated sugar alcohol or dilute aqueous solution thereof, and the whole is stirred for about five minutes. The obtained mixed solution is cooled to a temperature of 30° C. or less to obtain a liquid dispersion.

Usable examples of the sugar alcohol or dilute aqueous solution thereof include reduced sugar syrup, D-sorbitol, erythritol, D-mannitol, xylitol, reduced maltose syrup, and lactitol; however, the present invention is not limited to these. One type of sugar alcohol may be used in isolation, or two or more types may be used in a mixture or diluted with water.

Usable examples of the paste or powder of vegetables or fruit added to the sugar alcohol or dilute aqueous solution thereof include a paste or powder of natural ingredients, such as green soybeans, pumpkin, tomato, corn, ginger, purple sweet potato, shiso, Angelica keiskei, yuzu, lemon, or apple; however, the present invention is not limited to these. The paste or powder preferably has a particle size of 20 mesh or smaller, more preferably 30 mesh or smaller. It is vital that the paste or powder be of this particle size, as there is the possibility of the paste or powder not being uniformly distributed even after stirring and mixing, and settling to the bottom of the tofu, if this particle size is exceeded.

Usable examples of the colorant added to the sugar alcohol or dilute aqueous solution thereof include turmeric, Spirulina, and gardenia; however, the present invention is not limited to these.

Usable examples of the thickener added to the sugar alcohol or dilute aqueous solution thereof include locust bean gum, guar gum, carrageenan, pectin, gellan gum, xanthan gum, tara gum, and alginate; however, the present invention is not limited to these. One type of thickener may be used in isolation, or a mixture of two or more types may be used. The addition of the thickener improves the storage stability of the liquid dispersion, making it easier to mix the liquid dispersion and the soy milk.

Next, in step B, the liquid dispersion obtained in step A is mixed with soy milk and a coagulating agent. The soy milk with which the liquid dispersion is mixed maybe ordinary soy milk. In a preferred example, the composition of the liquid mixture following mixing is 3% liquid dispersion, 97% soy milk, and 3% coagulating agent. The liquid mixture is preferably stirred for about 10 minutes; this will yield a uniform liquid soy milk mixture.

Finally, in step C, the liquid soy milk mixture obtained in step B is coagulated by being steamed in a steamer. The coagulated liquid soy milk mixture is then cooled to obtain tofu.

Although not used in the embodiment described above, a natural flavoring and/or a synthetic flavoring may be further added to the liquid dispersion. Adding a natural flavoring and/or a synthetic flavoring allows for the enhancement of tofu flavors that would be weakly perceived if a paste or powder of vegetables or fruit was used.

### EXAMPLES

Examples of the present invention will now be described. Table 1 below lists compositions for liquid dispersions according to various examples and a comparative example. Table 2 below lists the composition of a liquid soy milk mixture used in the examples and comparative example. Comparative example 1 uses a green soybean paste of a different particle size than that used in example 1 of the present invention in order to compare differences yielded by paste particle size; the other ingredients are all identical to those used in example 1. Examples 2-4 use pastes of various amounts and particle size.

### Example 1

Example 1 will now be described. First, an 85.5% by weight aqueous solution of maltitol was weighed out and heated to 70° C. Next, 5.0% by weight blue colorant, 1.5% by weight yellow colorant, 5.0% by weight green soybean paste, 0.2% by weight xanthan gum, and 2.5% by weight spirits were added to the aqueous maltitol solution, and the whole was stirred for five minutes using a homomixer. The xanthan gum was first dispersed in the spirits before being added to the aqueous maltitol solution so as not to form lumps when added. Subsequently, the stirred liquid mixture was cooled to 30° C. or less in an icewater bath to obtain a liquid dispersion (see step A in FIG. 1).

TABLE 1
Composition (weight %) of liquid dispersion

| | Exam- | Exam- | Exam- | Exam- | Comparative |
|---|---|---|---|---|---|
| Ingredient | ple 1 | ple 2 | ple 3 | ple 4 | example 1 |
| Aqueous maltitol | 85.8 | 40.5 | 90.4 | 90.95 | 85.8 |
| solution | | | | | |
| Water | | 30.0 | | | |
| (sterilized) | | | | | |
| Colorant | | | | | |
| Blue | 5.0 | 5.0 | | | 5.0 |
| Yellow | 1.5 | 1.5 | 2.0 | 1.5 | 1.5 |
| Paste | | | | | |
| Green soybean | 5.0 | 20.0 | | | |
| (30 mesh or finer) | | | | | |
| Green soybean | | | | | 5.0 |
| (10 mesh or finer) | | | | | |
| Yuzu peel | | | 5.0 | | |
| (20 mesh or finer) | | | | | |
| Corn | | | | 5.0 | |
| (30 mesh or finer) | | | | | |
| Thickener | | | | | |
| Xanthan gum | 0.2 | | 0.05 | | 0.2 |
| Carrageenan | | | | 0.05 | |
| Locust bean gum | | 0.5 | 0.05 | | |
| Spirits | 2.5 | 2.5 | 2.5 | 2.5 | 2.5 |

Next we 3.0 g of the liquid dispersion obtained as described above were mixed with 97.0 g soy milk and 3.0 g nigari (see table 2). This liquid mixture was stirred for 10 minutes until uniform consistency was achieved, thereby obtaining a liquid soy milk mixture (see step B in FIG. 1).

TABLE 2
Composition of liquid soy milk mixture

| Ingredient | Amount (g) |
|---|---|
| Liquid | 3.0 |
| dispersion | |
| Soy milk | 97.0 |
| Nigari | 3.0 |

Finally, the liquid soy milk mixture obtained as described above was coagulated by being steamed for 10 minutes in the steamer, followed by left resting in the steamer for 10 minutes. The coagulated liquid soy milk mixture was chilled for two hours in a refrigerator to obtain tofu (see step C in FIG. 1).

### Examples 2-4

Tofu according to examples 2-4 was obtained according to conditions and a process similar to those used in example 1, except that the ingredient compositions for examples 2-4 shown in table 1 were used.

### Comparative Example 1

Tofu according to a comparative example 1 was obtained according to conditions and a process similar to those used in example 1, except that the ingredient composition for comparative example 1 shown in table 1 was used.

The liquid dispersions of the examples and the comparative example were left standing at 40° C. for 24 hours to confirm the stability thereof; results are shown in table 3. The liquid dispersions were rated according to a three-grade scale in which “A” indicates that the tofu was stable, “B” indicates that there was slight settling of paste particles, and “C” indicates that ingredients separated or the paste settled.

The tofu obtained according to the examples and comparative example was also observed for uniformity of colorants and vegetable or fruit paste; results are shown in table 3. In the table, “A” indicates a uniform consistency, and “C” indicates that the paste settled to the bottom. As shown in table 3, examples 1-4 yielded tofu in which the colorants and vegetable or fruit paste were uniformly dispersed.

TABLE 3
Results of evaluating liquid dispersion stability and tofu uniformity

| | Exam- | Exam- | Exam- | Exam- | Comparative |
|---|---|---|---|---|---|
| Item | ple 1 | ple 2 | ple 3 | ple 4 | example 1 |
| Liquid dispersion | A | A | A | B | A |
| stability | | | | | |
| Tofu uniformity | A | A | A | A | C |

Stability of liquid dispersion A: stable; B: paste settled slightly; C: ingredients separated or paste settled
Uniformity of tofu A: uniform; C: paste settled to bottom

What is claimed is:

1. A method for producing colored tofu, the method comprising steps of:
preparing a liquid dispersion constituted by a colorant and a paste or powder of vegetables or fruit uniformly dispersed in sugar alcohol or a dilute aqueous solution thereof;
preparing a liquid soy milk mixture by uniformly mixing the liquid dispersion, soy milk, and a coagulating agent; and
coagulating the liquid soy milk mixture to produce tofu.

2. The method for producing colored tofu according to claim 1, wherein the step of preparing the liquid dispersion uses a paste or powder of vegetables or fruit having a particle size of 20 mesh or smaller.

3. The method for producing colored tofu according to claim 1, wherein the step of preparing the liquid dispersion uses a paste or powder of vegetables or fruit having a particle size of 30 mesh or smaller.

4. The method for producing colored tofu according to claim 1, wherein the step of preparing the liquid dispersion comprises a step of further dispersing a thickener within the sugar alcohol or dilute aqueous solution thereof in an amount equivalent to 0.05-1.0% by weight with respect to the total weight of the liquid dispersion.

5. The method for producing colored tofu according to claim 1, wherein the step of preparing the liquid dispersion comprises a step of further dispersing a thickener within the sugar alcohol or dilute aqueous solution thereof in an amount equivalent to 0.1-0.5% by weight with respect to the total weight of the liquid dispersion.
